(19) United States
(12) Patent Application Publication
(10) Pub. No.: US 2002/0154071 A1
(43) Pub. Date: Oct. 24, 2002

(54) Superimposition of video signals on an operating data display

(75) Inventor: Michael Schuh, Rheinzabern (DE)

Correspondence Address: Robert J. Koch, Fulbright & Jaworski, LLP, 801 Pennsylvania Avenue, N.W., Washington, DC, 20004, US

(73) Assignee: Pat GmbH, Ettlingen (DE)

(21) Appl. No.: 10/106,816

(22) Filed: Mar. 27, 2002

(30) Foreign Application Priority Data
Mar. 28, 2001 (DE) DE 101 15 617.0
Jun. 7, 2001 (DE) DE 101 40 938.9

(51) Int. Cl. G09G 5/00

(52) U.S. Cl. 345/9

(57) ABSTRACT

A process and system for display of both motor vehicle operating data and scene images on a monitor located within the visual range of the motor vehicle operator. In particular, the present invention is useful for motor vehicles used in the construction industry. Scene image data is acquired by use of at least one image acquisition device, especially a camera, and the received images are superimposed on the monitor for display with motor vehicle operating data such as motor temperature, oil pressure, etc.

### BACKGROUND OF THE INVENTION

1. Field of the Invention

The present invention relates to a process and a system for the display of motor vehicle operating data, including the display of images for scenes adjacent the vehicle. More particularly the present invention provides for the display of operating data and scene images which is especially convenient for operators in situations where motor vehicles are operated in the construction industry.

2. Description of the Related Technology

In motor vehicles, especially vehicles in the construction industry, it is known that the motor vehicle operating data has been displayed in the visual range of the operator, especially the driver. Thus it is possible to be informed as to the instantaneous operating state of the motor vehicle which is very important when operating data deviates from normal ranges. For example, the revolutions per minute (rpm) of the motor, the motor operating temperature, the oil pressure, etc. of an internal combustion engine that powers a motor vehicle or the operating data for accessories and components used with a motor vehicle are displayed. Operating data for the working environment of a motor vehicle with which an operator has no visual contact at all or only limited visual contact is not be known or available.

### SUMMARY OF THE INVENTION

One object of the invention is to devise a simple process and system or device for displaying motor vehicle operating data, especially for motor vehicles used in the construction industry, by which it is ensured that operators can observe the working environment of their motor vehicles.

This and other objects may be achieved by superimposing camera viewed scenes on monitors used by motor vehicle operators for displaying vehicle operating data.

In both the process and also the device of the present invention, it is provided that operating data, especially that as occur on or around the vehicle, are acquired using image acquisition devices and these acquired images are superimposed on a monitor, in addition to other already displayed operating data. The present invention provides the previously unavailable advantage that events in the working area of the motor vehicle with which the operator has only limited or no visual contact are superimposed on the existing monitor. It thus can be assured that information needed for the safe operation of the motor vehicle is available. Hazardous situations, especially hazards to individuals or articles located in the working area of the motor vehicle, can be prevented or avoided. The received images are readily superimposed statically or dynamically on monitors so that existing hardware can be used to increase the operating reliability of motor vehicles. Installation of additional monitors including expensive power supplies and cabling are avoided. To do this the signals of the image acquisition devices, especially the video signals of cameras, are advantageously supplied to an existing control unit which often is in the operator's cab of the motor vehicle. According to the present invention images can be superimposed for display in a partial area of a monitor, or also displayed on the entire area of the monitor. When there are several cameras, the multiple images can be displayed on a pertinent partial area of the monitor. Thus, for example a camera can be pointed at the winch of a crane while another camera monitors the range of motion of the hook which is driven by the winch. Furthermore, a camera could observe one such area to help the operator, which may be an area where a load on a crane is to be picked up from or deposited and with which the crane operator can not see. One or more remote cameras could be connected, for example, wirelessly to the control unit of the motor vehicle, in the case of cameras installed on the motor vehicle the connections can be by wire (or optionally also wirelessly) to the control unit.

Furthermore, the control unit can be advantageously provided with a camera control input unit, and a camera can be triggered and controlled to move via the input unit, in order to choose or change the working environment to be imaged. Alternatively or in addition, using the input unit the cameras (or when there are several cameras a group of cameras) can be individually selected as to which of those having video signals are to be displayed on the monitor. The input unit for example can be a joystick, but also a pushbutton control.

### BRIEF DESCRIPTION OF THE DRAWINGS

One embodiment of the device and process according to the invention for displaying operating data of motor vehicles and scene image data in the construction industry, to which however the invention is not limited, is described below and explained using the figure, wherein:

FIG. 1 shows a block diagram for a preferred embodiment of the present invention.

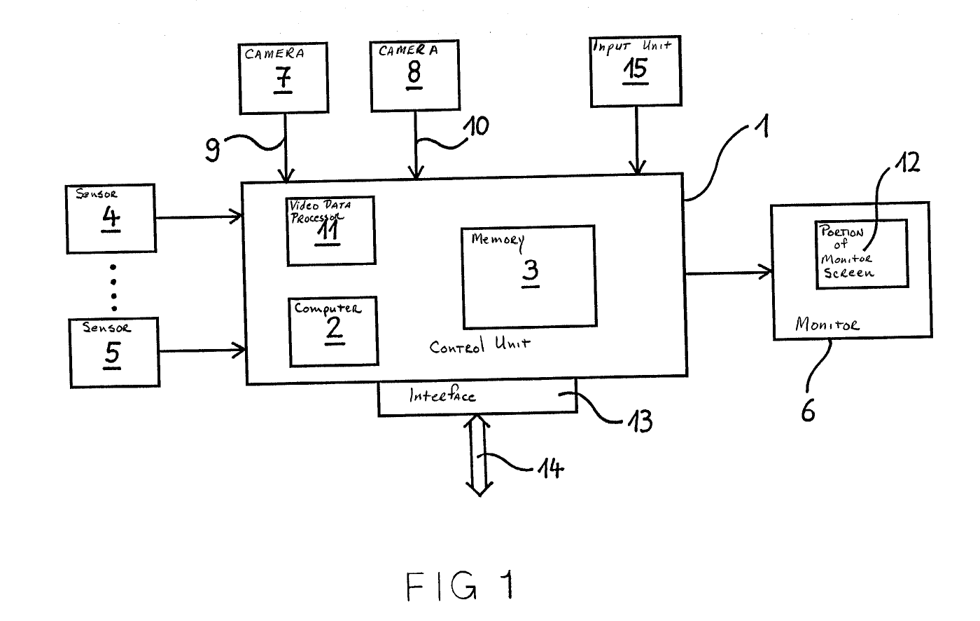

### DETAILED DESCRIPTION

A control unit 1 which is accommodated and mounted at a suitable site in the motor vehicle (not shown) has at least one computer 2 and a memory 3. At least one sensor, and often especially several sensors 4, 5 (or more), are connected to the control unit 1. The operating data acquired by the sensors 4, 5 (for example, the temperature of the internal combustion engine of the motor vehicle, the hydraulic pressure, battery and regulator voltages or the like) are supplied to the computer 2 of the control unit 1. Optionally the signals detected and provided by the sensors 4, 5 can be stored in the memory 3 at least partially for purposes of later evaluation and display. The signals of the sensors 4, 5 are conditioned by the computer 2 and relayed to a monitor 6 which is located in the visual range of the operator of the motor vehicle and are displayed on it.

Furthermore, according to the present invention at least one image acquisition device and preferably more than one, for example cameras 7, 8, are connected to the control unit 1. The received images are supplied by means of video signals from the cameras 7, 8 via either a cable 9 or via a wireless connection 10 to the control unit 1, especially its video data processor 11. Alternatively, the video signals of the cameras 7, 8 could be directly supplied to the computer 2, in which case the video data processor 11 could be omitted. The presence and use of the video data processor 11 for conditioning video signals from the cameras 7, 8 has the advantage of facilitating video data preparation, and therefore the performance of the computer 2 would not be adversely affected.

The video signals of the cameras 7, 8 which have been conditioned by the video data processor 11 (and/or the computer 2) are supplied to the monitor 6. The video signals, for example, can be processed to be displayed by being superimposed on the entire area of the monitor 6 or only on a partial area 12 of the monitor 6. This superpositioning of an image onto the partial area 12 has the advantage that both images acquired by pertinent cameras and also other operating data of the motor vehicle are simultaneously clearly displayed on the monitor 6.

In an alternative embodiment of the present invention, the control unit 1 has an interface 13 so that at least one camera can be connected via a data bus 14 to the interface 13 of the control unit 1. The same applies to at least one of the sensors which can likewise be connected via the data bus 14 to the interface 13 of the control unit 1. One such embodiment offers the advantage that when the sensors 4, 5 or cameras 7, 8 are connected via the data bus 14 independent cabling is not necessary, but the data bus 14 can be installed for example as a ring bus in the motor vehicle and the respective components can be connected to the pertinent sites.

Additionally, the control unit 1 can have an input unit 15, e.g., joystick, pushbutton control, etc., with which the working environment to be viewed can be selected by the operator who would use the input unit 15 to control the movement of the pertinent camera. Then the image provided by the camera could be superimposed on the partial area 12. Thus the operator can observe exactly the required working environment with one of the cameras 7, 8 adjacent where the work is underway. If the working environment should be observed with several cameras, then the input unit 15 can be used to position those cameras to observe the required working environment in an optimum configuration.

What is claimed is:

1. A monitoring and imaging system for use with a vehicle, the monitoring and imagining system comprising:
at least one sensor to monitor the operation of an engine powering the vehicle, said sensor providing an operating data system signal;
at least one image acquisition device to provide an image data signal for a viewed scene;
a monitor mounted adjacent a location for an operator of the vehicle so said monitor can be viewed by the vehicle operator; and
a computer to provide both said operating data signal and said image data signal to said monitor so operating data and image data are displayed to be viewed on said monitor.

2. The monitoring and imagining system of claim 1, further comprising a video data processor to provide said image data signal to said computer.

3. The monitoring and imaging system of claim 1, wherein said computer provides said image data signal to said monitor so the displayed image appears over a portion of a surface of said monitor.

4. The monitoring and imaging system of claim 1, further comprising wires to provide said image data signal from said image acquisition device to said computer.

5. The monitoring and imagining system of claim 2, further comprising wires to provide said image data signal from said image acquisition device to said video data processor.

6. The monitoring and imaging system of claim 2, further comprising a wireless transmission system to provide said image data signal from said acquisition device to said video data processor.

7. The monitoring and imaging system of claim 3, further comprising a wireless transmission system to provide said image data signal from said image acquisition device to said video data processor.

8. The monitoring and imaging system of claim 1, further comprising a video data processor connected to a data bus to provide said image data signal from said image acquisition device to said computer.

9. The monitoring and imaging system of claim 1, wherein said vehicle is a crane.

10. The monitoring and imaging system of claim 1, further comprising an input unit to control the direction that at least one image acquisition device is pointed to provide image data signals for a scene.

11. The monitoring and imaging system of claim 10, wherein said input unit is a joystick.

12. A method for displaying operating conditions of an engine powering a vehicle and for also displaying images of scenes adjacent the vehicle, the method including the steps of:
providing at least one operating parameter data signal for the engine powering the vehicle using a sensor;
providing at least one image data signal for a scene viewed adjacent the vehicle using an image acquisition device;
providing a monitor mounted adjacent a location for an operator of the vehicle so said monitor can be viewed by the vehicle operator; and
processing and providing both said operating parameter data signal and said image data signal to said monitor so operating data and image data are displayed to be viewed on said monitor.

13. The method of claim 12, further comprising the step of using a computer to process and provide both said operating parameter data signal and said image data signal to said monitor so operating data and image data are displayed to be viewed on said monitor.

14. The method of claim 13, further comprising the step of using a video data processor to provide said image data signal to said computer.

15. The method of claim 13, further comprising the step of using said computer to provide said image data signal to said monitor so the displayed image appears over a portion of a surface of said monitor.

16. The method of claim 13, further comprising the steps of using wires to provide said image data signal from said image acquisition device to said computer.

17. The method of claim 14, further comprising the step of using wires to provide said image data signal from said image acquisition device to said video data processor.

18. The method of claim 13, further comprising the step of using a wireless transmission system to provide said image data signal from said image acquisition device to said computer.

19. The method of claim 14, further comprising the step of using a wireless transmission system to provide said image data signal from said image acquisition device to said video data processor.

20. The method of claim 13, further comprising the step of providing a video processor connected to a data bus to provide said image data signal from said image acquisition device to said computer.

21. The method of claim 12, further comprising the step of provide an input unit to control the direction that at least one image acquisition device is pointed to provide image data signals for a scene.
